(19) United States
(12) Patent Application Publication
(10) Pub. No.: US 2026/0145925 A1
(43) Pub. Date: May 28, 2026

(54) ROTARY APPARATUS AND METHOD FOR SEALING A ROTARY APPARATUS

(71) Applicant: KRONES AG, Neutraubling (DE)

(72) Inventors: Markus SCHOENFELDER, Regensburg (DE); Franz BRAUN, Bad Abbach (DE)

(21) Appl. No.: 19/398,788

(22) Filed: Nov. 24, 2025

(30) Foreign Application Priority Data
Nov. 26, 2024 (DE) 10 2024 134 757.0

(51) Int. Cl. B67C 7/00

(52) U.S. Cl. CPC B67C 7/008

(57) ABSTRACT

The invention relates, inter alia, to a rotary apparatus for a container processing plant. The rotary apparatus comprises a support frame having a cut-out and an annular lubricant channel surrounding the cut-out. The rotary apparatus comprises a rotor plate which is arranged in the cut-out such as to be rotatable relative to the support frame and which has an annular collar which extends into the lubricant channel from above.

### TECHNICAL FIELD

The invention relates to a rotary apparatus for a container processing plant. The invention also relates to a method for sealing a rotary apparatus.

### TECHNICAL BACKGROUND

Rotary apparatuses, also referred to as rotary machines, are machines that are used, for example, in container processing plants, such as beverage filling plants. These machines are configured to move containers, such as bottles or cans, on a circular path and can optionally process them. A typical feature of a rotary machine is that it rotates about a vertical axis.

For example, a rotary can sealer can be used in the beverage and food industry to seal cans efficiently and quickly. Such machines operate in a continuous cycle and are configured to process multiple cans simultaneously. The machine can rotate about a central axis, wherein the cans are guided in a circular arrangement through various processing steps. This may include applying and crimping the lid to ensure an airtight seal.

With increased hygiene requirements, there may be a regular need to clean the rotary apparatuses. During cleaning, jets of cleaning liquid may impinge on surfaces of the rotary apparatus.

A disadvantage of known rotary apparatuses, in particular rotary can sealers, can be that they have insufficient sealing against the cleaning liquid. Accordingly, there is a risk that the cleaning liquid might enter a lubricant space of the rotary apparatus through gaps etc. and contaminate the lubricant therein, thus reducing its effectiveness.

On the other hand, no lubricant should get from the lubricant space into the production space/container processing space.

Furthermore, with conventionally used sealing systems, such as shaft seals, X-rings and O-rings, negative effects can occur at high speeds of the carousels due to the seal. The primary negative effect is a high heat input. This in turn leads to abrasion and to the respective sealing system wearing out relatively quickly, thus becoming leaky again.

The invention is based on the object of creating an improved sealing for a rotary apparatus, with which at least some of the aforementioned disadvantages can be overcome. Preferably, the improved sealing should make possible a reliable sealing of a lubricant space of the rotary apparatus, in particular during cleaning work, so that no cleaning liquid enters the lubricant space. Preferably, the sealing should be usable in the case of rotary closing apparatuses, in particular rotary can closing apparatuses.

### SUMMARY OF THE INVENTION

The object is achieved by the features of the independent claims. Advantageous developments are specified in the dependent claims and the description.

One aspect relates to a rotary apparatus, preferably a rotary closing apparatus, preferably a rotary can-closing apparatus, for a container processing plant. The rotary apparatus comprises a support frame having a (e.g. central) cut-out and an annular lubricant channel surrounding the cut-out. The rotary apparatus has a rotor plate which is arranged in the cut-out such as to be rotatable relative to the support frame and has an annular collar which extends into the lubricant channel from above, preferably for sealing a gap between the rotor plate and the support frame by means of lubricant received in the lubricant channel.

Advantageously, the collar of the rotor plate, which extends into the lubricant channel filled with lubricant, creates a lubricant lock (e.g. oil lock), which can prevent, for example, cleaning medium from penetrating the support frame through a gap between the rotor plate and the support frame. The seal is advantageously low-friction, durable and hermetically sealed. As part of a sealing system, the lubricant lock can advantageously improve the seal between a container processing space (production space/hygiene space) and a lubricant space. The sealing system can advantageously ensure complete tightness so that no lubricant enters the container processing space and no water, steam or cleaning agent gets into the lubricant (lubricant circuit).

In one exemplary embodiment, the collar of the rotor plate is arranged on an outer circumference of the rotor plate and/or on an underside of the rotor plate. Advantageously, the lubricant lock can be arranged in a radially outer region of the rotor plate.

In a further exemplary embodiment, the support frame and the rotor plate are arranged, preferably directly, above or below a container processing space of the rotary apparatus, and/or the support frame and the rotor plate are components of a, preferably height-adjustable, (e.g. capper) upper part or (e.g. capper) lower part of the rotary apparatus. Advantageously, the seal can thus separate a region below the rotor plate, where containers are processed and cleaning agents are applied, and a region within the support frame where lubricating fluid circulates.

In one embodiment, the support frame encloses a lubricant space for receiving lubricant spray mist. The lubricant space is arranged above the lubricant channel and extends all the way to the lubricant channel for supplying the lubricant channel with the lubricant from the lubricant space. Advantageously, to ensure the sealing function the lubricant channel can always be kept full by circulating machine lubrication. The lubricant channel may partially leak due to centrifugal force. Advantageously, however, lubricant is continuously replenished from the lubricant space.

In a further embodiment, the support frame has an annular further lubricant channel which surrounds the lubricant channel, preferably coaxially, and optionally has an inlet of a lubricant drain for discharging lubricant from the further lubricant channel. Preferably, the further lubricant channel and the lubricant channel can be separated from each other (e.g. only) by an annular wall preferably having a wall height 5 mm and/or s 20 mm, preferably approximately 10 mm. Advantageously, the lubricant from the further lubricant channel, which receives lubricant that, for example, overflows from the lubricant channel, can flow via the lubricant drain to a lubricant reservoir (e.g. below the rotary apparatus), be processed there and be pumped back into the lubricant space. The wall can advantageously ensure that the lubricant channel always remains sufficiently full, even without replenishment, to ensure a hermetic seal.

In one embodiment variant, the rotor plate can rotate about a main axis of rotation of the rotary apparatus. Preferably, the rotor plate can be connected to processing devices for processing the containers and/or to container holders for rotating the processing devices and/or the container holders about the main axis of rotation of the rotary apparatus. The processing devices can preferably comprise closing tools, particularly preferably crimping closing tools. The proposed sealing technique can thus be used particularly advantageously in a can seamer.

In a further embodiment variant, the rotary apparatus further comprises a sealing ring which is arranged, for example, radially inwardly of the collar of the rotor plate and/or the lubricant channel of the support frame and creates a seal between the rotor plate, preferably an underside of the rotor plate, and the support frame. Preferably, the sealing ring may have a sealing lip that contacts the rotor plate, preferably from below. It is also possible for the sealing ring to be accommodated in the rotor plate and to have, for example, a sealing lip that contacts the support frame, e.g. its collar. The addition of the sealing ring can advantageously further improve the sealing effect. As a sliding seal, the sealing ring can advantageously prevent media (e.g. cleaning media) from the container processing space from reaching the lubricant lock at all and prevent lubricant from entering the container processing space.

In one exemplary embodiment, the rotor plate has an annular recess on the underside. Preferably, the recess can be delimited on the outer circumference by the collar of the rotor plate. The support frame can preferably have an annular collar which projects into the recess, e.g. from below, and preferably delimits the lubricant channel on the inner circumference. Advantageously, a sealing labyrinth can thus be realized between the surfaces of the recess and the collar of the support frame.

In a further exemplary embodiment, the sealing ring is arranged in the recess and creates a seal between the rotor plate and the collar of the support frame. Optionally, the sealing ring can be arranged and preferably supported at an upper end of the collar of the support frame. The sealing ring can thus advantageously prevent media, which have managed, in an already significantly reduced amount, to overcome the sealing labyrinth between the recess and the collar of the support frame, from penetrating the support frame.

In one embodiment, at least one of the following conditions is met:
an (e.g. annular) bottom surface of the recess has (e.g. in cross-section) a drip edge contour for interrupting a centrifugally induced droplet movement radially outwards;
an (e.g. annular) inner circumferential surface of the recess has (e.g. in cross-section) a breakwater contour for throwing back liquid entering (e.g. in jet form) the recess from below;
a transition between an (e.g. annular) inner circumferential surface of the recess and an (e.g. annular) bottom surface of the recess has a depression (e.g. undercut) for reducing a capillary effect between an inner circumferential surface of the recess and the collar of the support frame; and
an underside surface of the rotor plate radially inwardly adjacent to the recess has (e.g. in cross-section) a drip edge contour for interrupting a centrifugally induced droplet movement radially outwards towards the recess.

Advantageously, this allows a particularly effective labyrinth to be realized to protect against media from the container processing space.

In a further embodiment, the rotary apparatus further comprises (at least) one venting element, preferably a venting screw, which is releasably arranged in a through-hole of the rotor plate connected to the recess for reducing pressure in the recess. Preferably, at least one of the following conditions can also be met:
the venting element is releasably screwed into the through-hole;
the through-hole opens in a region of the recess between the collar of the support frame and the collar of the rotor plate; and
the through-hole opens in an upper side or outer circumferential side of the rotor plate.

Advantageously, the venting element can reduce a pressure increase in the recess caused, for example, by the rotation of the rotor plate or application of pressure in the container processing space (e.g. clean space). This can advantageously improve the sealing effect between the rotor plate and the support frame. Advantageously, the lubricant can be released outwards through the venting element by rotation in the radial direction. This is preferably only possible if air can enter the otherwise closed room.

In one embodiment variant, the rotary apparatus further comprises (at least) one sealing assembly comprising a sleeve part and a sealing screw. Preferably, the sleeve part can be arranged on an upper side of the rotor plate, preferably sealed in relation to the upper side of the rotor plate, and can extend into a passage of the rotor plate, preferably screwed into the passage. Preferably, the passage can extend from the upper side of the rotor plate to the recess, preferably into a region of the recess between an inner circumferential surface of the recess and the collar of the support frame. Optionally, the sealing screw can be sealed and releasably screwed into the sleeve part. Releasing the sealing assembly, e.g. during an inspection, can advantageously provide access to the recess in order to inspect the recess, if necessary, or to clean it. The sealed arrangement with sleeve part and sealing screw can advantageously prevent lubricating fluid still present on the upper side of the rotor plate from flowing into the recess when the sealing screw is removed.

A further aspect relates to a container processing plant (e.g. for controlling temperature, producing, cleaning, coating, testing, filling, closing, pasteurizing, decorating, labeling, printing, marking, laser marking, and/or packaging containers for liquid or pasty media, preferably beverages, liquid foods, or products from the pharmaceutical or healthcare industry). The container processing plant can comprise the rotary apparatus as disclosed herein. The container processing plant can, for example, be a beverage filling plant.

For example, the containers can be realized as bottles, cans, canisters, cartons, vials, tubes, etc.

Another aspect relates to a method for sealing a rotary apparatus, preferably as disclosed herein, or a rotary closing apparatus or a rotary can-seaming apparatus. The method comprises: blocking a fluid path (e.g. from between a container processing space of the rotary apparatus and a lubricant space of a support frame) through a gap between a rotor plate of the rotary apparatus and a support frame of the rotary apparatus by means of an annular collar of the rotor plate which extends into an annular lubricant channel of the support frame filled with lubricant. Advantageously, the method can achieve the same advantages as already described with reference to the rotary apparatus. The same applies to the preferred examples of the method described hereinafter.

In one exemplary embodiment, the method further comprises at least one of the following:
cleaning an underside of the rotor plate with a cleaning medium (e.g. in jet form), wherein penetration of the cleaning medium into a lubricant space enclosed by the support frame is prevented by the blocked fluid path;
replenishing, preferably continuously replenishing, the lubricant in the lubricant channel from a lubricant spray mist from a lubricant space enclosed by the support frame, which is arranged above the lubricant channel and extends all the way to the lubricant channel; and
sealing the gap with a sealing ring, preferably with a sealing lip of the sealing ring in contact with the rotor plate.

In a further exemplary embodiment, the rotor plate has an annular recess on the underside, wherein the recess is preferably delimited on the outer circumference by the annular collar of the rotor plate, and the support frame has an annular collar which projects into the recess and preferably delimits the lubricant channel on the inner circumference. The method further comprises at least one of: reducing pressure in the recess by (at least) one venting element, preferably a venting screw; and reducing a fluid flow through the recess by at least one of:
a drip edge contour on an (e.g. annular) bottom surface of the recess, which interrupts a centrifugally induced droplet movement radially outwards;
a breakwater contour on an (e.g. annular) inner circumferential surface of the recess, which throws back (e.g. in jet form) liquid penetrating the recess from below;
a depression (e.g. undercut) at a transition between an (e.g. annular) inner circumferential surface of the recess and an (e.g. annular) bottom surface of the recess, which reduces a capillary effect between the inner circumferential surface of the recess and the collar of the support frame; and
a drip edge contour on an underside surface of the rotor plate radially inwardly adjacent to the recess, which interrupts a centrifugally induced droplet movement radially outwards towards the recess.

The preferred embodiments and features of the invention described above can be combined with one another as desired.

It is to be understood that all features disclosed herein with respect to the rotary apparatus are also disclosed and claimable for the method, and vice versa.

### BRIEF DESCRIPTION OF THE FIGURES

Further details and advantages of the invention are described below with reference to the accompanying drawings. in the figures:

FIG. 1 shows a perspective sectional view of a rotary apparatus according to an exemplary embodiment; and

FIG. 2 shows a sectional view of a sealing system of the exemplary rotary apparatus.

The embodiments shown in the drawings correspond at least in part, so that similar or identical parts are provided with the same reference signs and reference is also made to the description of other embodiments or figures for the explanation thereof to avoid repetition.

### DETAILED DESCRIPTION OF EMBODIMENTS

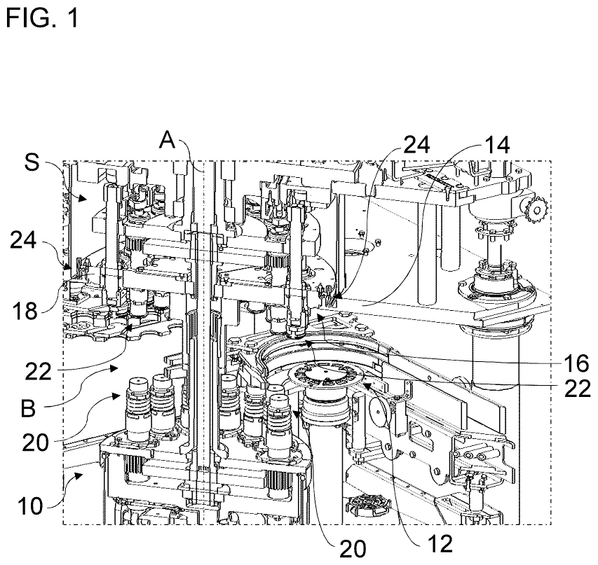

FIG. 1 shows a section of a rotary apparatus 10. Preferably, the rotary apparatus 10 can be included in a container processing plant, e.g. a beverage filling plant. For example, the rotary apparatus 10 can transfer the containers to a transport star 12 of the container processing plant.

The rotary apparatus 10 can preferably be a rotary processing apparatus for processing containers, e.g. a rotary closing apparatus for closing containers filled with a filling material. Preferably, the containers can be cans, e.g. beverage cans. Correspondingly, the rotary apparatus 10 can particularly preferably be a rotary can-seaming apparatus, as shown by way of example in FIG. 1.

For example, a filling apparatus for filling the containers with a, preferably liquid or pasty, filling material can be arranged upstream of the rotary closing apparatus. The filled containers can, for example, be transported to the rotary closing apparatus by a conveyor and then closed by the rotary closing apparatus.

The rotary apparatus 10 has a support frame 14 and a rotor plate 18.

The support frame 14 can also be referred to as a support structure or machine bed. The support frame 14 is preferably stationary. The support frame 14 has a cut-out 16. The cut-out 16 can preferably be central with respect to a main axis of rotation A of the rotary apparatus 10. The cut-out 16 can preferably be circular.

The support frame 14 can preferably house a lubricant space S. Lubricant, e.g. lubricating oil, can be fed into the lubricant space S by means of a lubricant supplier. Preferably, a lubricant spray mist, e.g. a lubricating oil spray mist, can be contained in the lubricant space S. Bearings, bushings, etc. in the lubricant space S or adjacent thereto can be lubricated by the lubricant in the lubricant space S.

The rotor plate 18 is rotatable about a main axis of rotation A of the rotary apparatus 10. Thus, the rotor plate 18 is also rotatable relative to the support frame 14. For example, the rotor plate 18 can be driven to rotate about a main axis of rotation A of the rotary apparatus 10. The rotor plate 18 is arranged in the cut-out 16. Preferably, the rotor plate 18 can delimit the lubricant space S downwards.

The rotor plate 18 can, for example, be part of a so-called control drum/control cage of a rotary closing apparatus.

Preferably, the support frame 14 and the rotor plate 18 can be components of a, preferably height-adjustable, (e.g. capper) upper part of the rotary apparatus 10, as shown by way of example in FIG. 1.

The support frame 14 and the rotor plate 18 can be arranged directly above a container processing space B of the rotary apparatus 10. During operation of the rotary apparatus 10 the containers can pass through the container processing space B. In the container processing space B, the containers can be processed by the rotary apparatus 10.

For example, the rotary apparatus 10 can have several container stations for processing (e.g. closing) several containers in the container processing space B simultaneously or in a time-overlapping manner. Preferably, the container stations can be arranged so as to be distributed about a circumference of a carousel of the rotary apparatus 10, e.g. on a carousel upper part and/or on a carousel lower part of the rotary apparatus 10.

For example, the container stations can each have a container holder 20 and a processing device 22.

The container holders 20 can hold and/or carry the containers. For example, the container holders 20 can each hold and/or carry a container. For example, the container holders 20 can support the containers on the bottom side. Optionally, the container holders 20 can rotate the containers about an (e.g. vertical) axis of the respective container holder 20, e.g. to support processing by the processing device 22 of the respective container station. The container holders 20 can, for example, be arranged on a rotatable carousel lower part of the rotary apparatus 10 for rotation about the main axis A of the rotary apparatus 10.

The processing devices 22 can process the containers held by the container holders 20 in the container processing space B. For example, the processing devices 22 can each process a container.

For example, the processing devices 22 can have closing tools for closing the containers in the container processing space B. The closing tools can, for example, be configured to close containers that are designed as cans. Accordingly, the closing tools can comprise, for example, crimping tools, e.g. with crimping roller(s) and counterholder, as shown by way of example in FIG. 1. Crimping tools can, for example, seam a seam edge of a can to hold a can lid, e.g. first with a pre-seam using a first crimping tool and then with a final seam using a second crimping tool.

The processing devices 22 can be arranged on a rotatable carousel upper part of the rotary apparatus 10 for rotation about a main axis A of the rotary apparatus 10. For example, the processing devices 22 can be at least partially connected to the rotor plate 18 for rotation about the main axis of rotation A. Preferably, the crimping tools with the crimping rollers (e.g. for the pre-seam and final seam) can be connected to the rotor plate 18 for rotation about the main axis of rotation A.

For example, the processing devices 22 can extend at least partially through passages in the rotor plate 18 from the lubricant space S into the container processing space B, preferably so as to be sealed relative to the rotor plate 18.

A sealing system 24 is provided for sealing between the rotor plate 18 and the support frame 14. The sealing system 24 can create a seal between the rotor plate 18 and the support frame 14 and thus between the container processing space B and the lubricant space S.

It goes without saying that the rotary apparatus 10—depending on its configuration—can have further or alternative rotor plates in addition to the rotor plate 18, as already shown in FIG. 1 (see upper part and lower part of the apparatus 10). The technique proposed herein regarding the sealing system 24, i.e. the seal between the rotor plate 18 and the support frame 14, can be applied to all conceivable rotor plate/support frame combinations of a rotary apparatus and is not limited to the application described herein to the rotor plate 18 or to an application in a can seaming apparatus, even though such applications are particularly preferred.

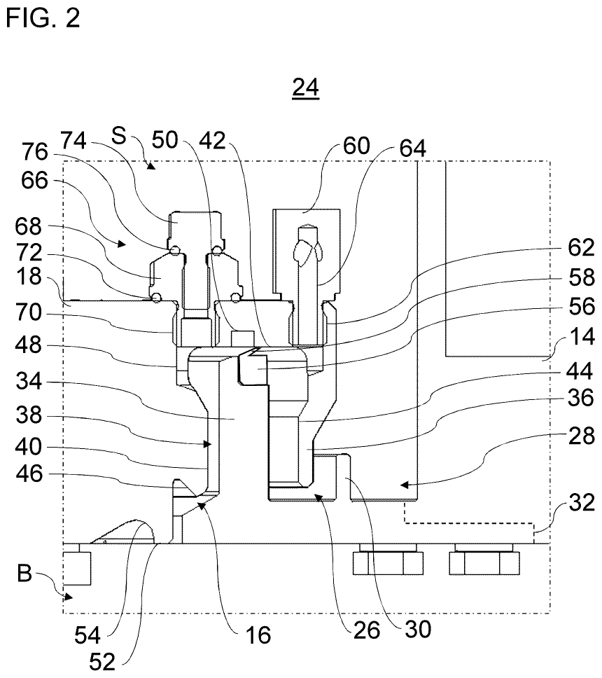

FIG. 2 shows the sealing system 24 in greater detail.

The sealing system 24 can be formed by a special shaping of the support frame 14 and the rotor plate 18, as will be described in detail below. Optionally, the sealing system 24 can further comprise a sealing ring 56, at least one venting element 60 and/or at least one sealing assembly 66.

The support frame 14 has an annular lubricant channel 26. Optionally, the support frame 14 can, for example, have yet another annular lubricant channel 28 and/or an annular collar (flange) 34.

The lubricant channel 26 surrounds the cut-out 16. The lubricant channel 26 can preferably extend on a circular path through the center of which the main axis of rotation A of the rotary apparatus 10 (see FIG. 1) runs.

During operation, the lubricant channel 26 is filled with lubricant, preferably lubricating oil.

For example, the lubricant space S enclosed by the support frame 14 can be arranged above the lubricant channel 26. The lubricant space S can extend downwards to the lubricant channel 26. Lubricant in the form of, for example, lubricant spray mist can be supplied from the lubricant space S to the lubricant channel 26 for filling the lubricant channel 26 with lubricant.

The further lubricant channel 28 can preferably also extend on a circular path through the center of which the main axis of rotation A of the rotary apparatus 10 (see FIG. 1) runs. The further lubricant channel 28 can surround the lubricant channel 26, preferably coaxially.

The further lubricant channel 28 can be arranged externally to the lubricant channel 26. Accordingly, the further lubricant channel 28 can also be referred to as an outer lubricant channel, and the lubricant channel 26 can be referred to as an inner lubricant channel.

Preferably, the lubricant channels 26 and 28 are directly adjacent to each other. For example, the lubricant channels 26 and 28 may be separated from each other by an annular wall 30. The wall 30 (and thus preferably also the lubricant channel 26) can preferably have a height 5 mm and s 20 mm, preferably approximately 10 mm. The wall 30 can limit the lubricant channel 26 on the outer circumference. The wall 30 can limit the further lubricant channel 28 on the inner circumference.

An inlet of a lubricant drain 32 (shown only schematically in FIG. 2) may be connected to the further lubricant channel 28. For example, the inlet can be arranged in a bottom surface or an outer circumferential surface of the further lubricant channel 28. Lubricant can be discharged through the lubricant drain from the further lubricant channel 28, e.g. to a lubricant recirculation path in which the lubricant can be, for example, filtered and conveyed, e.g. pumped, back to the lubricant space S and/or other lubricant spaces of the rotary apparatus 10 (see FIG. 1).

It is also possible, for example, that there is no further lubricant channel 28. Instead, for example, an overflow can be arranged in or on the lubricant channel 26. The inlet of the lubricant drain 32 can be arranged at the overflow. Advantageously, the overflow could also be used to adjust the lubricant level, e.g. oil level.

The further lubricant channel 28 can receive lubricant that overflows from the lubricant channel 26. During operation, when the rotor plate 18 rotates, the lubricant from the lubricant channel 26 can partially spill over the wall 30 and into the further lubricant channel 28.

The lubricant space S enclosed by the support frame 14 can also be arranged above the further lubricant channel 28. The lubricant space S can extend downwards to the further lubricant channel 28. Lubricant in the form of, for example, lubricant spray mist can be supplied from the lubricant space S to the further lubricant channel 28 for draining via the lubricant drain 32.

The collar 34 of the support frame 14 can extend on a circular path through the center of which the main axis of rotation A of the rotary apparatus 10 (see FIG. 1) runs. The collar 34 may preferably be arranged on an inner circumference of the support frame 14. The collar 34 is preferably completely circumferential.

For example, the collar 34 can delimit the cut-out 16 on the outer circumference. For example, the collar 34 can limit the lubricant channel 26 on the inner circumference.

Preferably, the collar 34 can extend upwards. The collar 34 may preferably be higher than the wall 30.

The rotor plate 18 has an annular collar (flange) 36. The collar 36 can also be referred to as a collar plate. Optionally, the rotor plate 18 can also have an annular recess 38.

The collar 36 of the rotor plate 18 can extend on a circular path through the center of which the main axis of rotation A of the rotary apparatus 10 (see FIG. 1) runs. The collar 36 is preferably arranged on an outer circumference of the rotor plate 18. The collar 36 may be arranged on an underside of the rotor plate 18. The collar 36 is preferably completely circumferential.

Preferably, the collar 36 of the rotor plate 18 and the lubricant channel 26 of the support frame 14 run coaxially relative to the main axis of rotation A of the rotary apparatus 10 (see FIG. 1).

The collar 36 extends, from above, into the lubricant channel 26 and thus into the lubricant in the lubricant channel 26. The collar 36 can extend into the lubricant channel 26 at a distance from a bottom surface, an inner circumferential surface and an outer circumferential surface of the lubricant channel 26.

A gap between the rotor plate 18 and the support frame 14 can be sealed by the collar 36 extending into the lubricant channel 26 and the lubricant contained therein. The gap may be present for functional reasons, since the rotor plate 18 is rotatable relative to the support frame 14. The collar 36, the lubricant channel 26 and the lubricant contained therein can interact as a lubricant lock, preferably an oil lock. Accordingly, the lubricant lock can create a seal between the lubricant space S and the container processing space B.

The collar 36 of the rotor plate 18 extending into the lubricant-filled lubricant channel 26 can thus effectively block a fluid path (e.g. for cleaning liquid) through the gap between the rotor plate 18 and the support frame 14. When cleaning, among other things, the underside of the rotor plate 18 with a cleaning medium that is sprayed, for example, onto the underside, the cleaning medium can be prevented from entering the lubricant space S by means of the blocked fluid path.

The recess 38 may be arranged on an underside of the rotor plate 18. The recess 38 can be delimited on the outer circumference by the collar 36 of the rotor plate 18.

The recess 38 may have a substantially U-shaped cross-section, preferably oriented as an inverted U. The U-shaped cross-section of the recess 38 can be formed by an inner circumferential surface 40, a bottom surface 42 and an outer circumferential surface 44. Preferably, the outer circumferential surface 44 of the recess 38 can be formed by an inner circumferential surface of the collar 36 of the rotor plate 18. The bottom surface 42 may face downwards. The bottom surface 42 may also be referred to as an overhead bottom surface 42.

The collar 34 of the support frame 14 can insert into the recess 38 from below or extend into the recess 38. The collar 34 of the support frame 14 may be spaced apart from the inner circumferential surface 40, the bottom surface 42 and the outer circumferential surface 44 of the recess 38.

Preferably, the inner circumferential surface 40 of the recess 38 has a breakwater contour 46 in cross-section. The breakwater contour 46 can be shaped so that it can throw back liquid penetrating into the recess 38 from below along the inner circumferential surface 40. For example, the breakwater contour 46 can be formed by an inwardly and downwardly directed projection on the inner circumferential surface 40. For example, the breakwater contour 46 may have substantially an inverted U-shape or an inverted V-shape. The breakwater contour 46 is preferably a closed contour, i.e. a contour that runs completely around the inner circumferential surface 40.

A transition between the inner circumferential surface 40 and the bottom surface 42 of the recess 38 preferably has a depression 48. The depression 48 can be realized as a groove, for example. Preferably, the depression 48 may be formed as an undercut at the transition between the inner circumferential surface 40 and the bottom surface 42. The depression 48 can serve to reduce a capillary effect between the inner circumferential surface 40 of the recess 38 and the collar 34 of the support frame 14. Accordingly, the depression 48 can be referred to, for example, as a so-called capillary groove.

Preferably, the bottom surface 42 of the recess 38 has a drip edge contour (drip-off edge contour) 50 in cross-section. The drip edge contour 50 can be shaped so as to interrupt a centrifugally induced droplet movement radially outwards along the bottom surface 42. For example, the drip edge contour 50 can form a step-shaped shoulder in the bottom surface 42. The drip edge contour 50 is preferably a closed contour, i.e. a contour that runs completely around the bottom surface 42.

Preferably, an underside surface 52 of the rotor plate 18, which radially inwardly adjoins the recess 38, can have a drip edge contour 54 in cross-section. The drip edge contour 54 can be shaped such as to interrupt a centrifugally induced droplet movement along the underside surface 52 radially outwards towards the recess 38. For example, the drip edge contour 54 can form a step-shaped shoulder in the underside surface 52. The drip edge contour 54 is preferably a closed contour, i.e. a contour that runs completely around the underside surface 52.

Accordingly, the breakwater contour 46, the drip edge contours 50 and 54 and the depression 48 can contribute to reducing a fluid flow (e.g. of cleaning liquid) from the container processing space B through the recess 38.

The sealing ring 56 may create a seal between the rotor plate 18 and the support frame 14. Preferably, the sealing ring 56 can seal a gap between an underside of the rotor plate 18 and the collar 34 of the support frame 14.

The sealing ring 56 can preferably be arranged in the recess 38. In detail, the sealing ring 56 can be arranged radially inwards of the collar 36 of the rotor plate 18 and the lubricant channel 26 of the support frame 14. Preferably, the sealing ring 56 can be arranged and supported at an upper end of the collar 34 of the support frame 14.

The sealing ring 56 can preferably have a sealing lip 58. The sealing lip 58 can contact an underside of the rotor plate 18. The sealing lip 58 can preferably contact the bottom surface 42.

Preferably, the further lubricant channel 28 of the support frame 14 and/or the collar 34 of the support frame 14 and/or the recess 38 of the rotor plate 18 and/or the sealing ring 56 run coaxially relative to the main axis of rotation A of the rotary apparatus 10 (see FIG. 1).

The venting element 60 can be arranged in a through-hole 62 of the rotor plate 18 connected to the recess 38. For example, the venting element 60 can be releasably secured, preferably screwed, in the through-hole 62. The venting element 60 can be a venting screw, for example.

The through-hole 62 may connect an upper side of the rotor plate 18 and the recess 38, for example. Alternatively, the through-hole 62 could, for example, connect an outer circumferential side of the rotor plate 18 and the recess 38 (not shown in FIG. 2). Accordingly, the through-hole 62 can open, on the one hand, in an upper side or outer circumferential side of the rotor plate 18.

On the other hand, the through-hole 62 can preferably open in a region of the recess 38 between the collar 34 of the support frame 14 and the collar 36 of the rotor plate 18. For example, the through-hole 62 can open in the bottom surface 42 (as shown in FIG. 2) or open in the outer circumferential surface 44 (not shown in FIG. 2).

If the sealing ring 56 is included, the through-hole 62 can preferably open in a region of the recess 38 between the sealing ring 56 and the collar 36 of the rotor plate 18, e.g. in the bottom surface 42 or the outer circumferential surface 44.

Preferably, the recess 38 can be vented by the venting element 60 and thus a pressure in the recess 38 can be reduced. According to the preferred arrangement, the region of the recess 38 between the collar 34 of the support frame 14/the sealing ring 56 and the collar 36 of the rotor plate 18 can be vented by the venting element 60 and thus any overpressure in this region can be reduced or a negative pressure can be prevented (e.g. air in, lubricant out or lubricant in and air out).

The venting element 60 preferably has an internal venting channel 64 for venting the recess 38. Any lubricant penetrating from the lubricant space S through the venting channel 64 can drip through the recess 38 from above and into the lubricant channel 26.

Preferably, several venting elements 60 are included. The venting elements 60 may be arranged in spaced-apart through-holes 62 of the rotor plate 18. The through-holes 62 can be arranged in a manner distributed along a course of the recess 38.

The sealing assembly 66 can comprise a sleeve part 68 and a sealing screw 74.

The sleeve part 68 can be arranged on an upper side of the rotor plate 18 and extend into a passage 70 of the rotor plate 18.

For example, the passage 70 may connect an upper side of the rotor plate 18 and the recess 38. The passage 70 may preferably extend from the upper side of the rotor plate 18 to the recess 38. Preferably, the passage 70 can open in a region of the recess 38 between the inner circumferential surface 40 and the collar 34 of the support frame 14, e.g. in the bottom surface 42.

If the sealing ring 56 is included, the passage 70 can preferably open in a region of the recess 38 between the inner circumferential surface 40 and the sealing ring 56, e.g. in the bottom surface 42.

Preferably, the sleeve part 68 can be releasably fastened, preferably screwed, in the passage 70. Preferably, the sleeve part 68 can be sealed with respect to the upper side of the rotor plate 18. For example, a sealing ring 72, e.g. O-ring, can create a seal between the upper side of the rotor plate 18 and the sleeve component 68.

The sealing screw 74 can be releasably screwed into the sleeve part 68. Preferably, the sealing screw 74 can be sealed to the sleeve part 68. For example, a sealing ring 76, e.g. O-ring, can create a seal between the sealing screw 74 and the sleeve part 68.

Preferably, several sealing assemblies 66 are included. The sealing assemblies 66 can be arranged at spaced-apart passages 70 of the rotor plate 18. The passages 70 can be distributed along a course of the recess 38.

The invention is not limited to the preferred exemplary embodiments described above. Rather, a plurality of variants and modifications are possible which likewise make use of the inventive concept and therefore fall within the scope of protection. In particular, the invention also claims protection for the subject matter and the features of the dependent claims, irrespective of the claims to which they refer. In particular, the individual features of independent claim 1 are each disclosed independently of one another. In addition, the features of the dependent claims are also disclosed and claimable independently of all of the features of independent claim 1 and, for example, independently of the features relating to the presence and/or configuration of the support frame, the lubricant channel, the cut-out, the rotor plate and/or the collar of independent claim 1. All ranges specified herein are to be understood as disclosed and claimable in such a way that all values falling within the relevant range are individually disclosed, e.g. also as the relevant preferred narrower outer limits of the relevant range.

### LIST OF REFERENCE SIGNS

| | |
|---|---|
| 10 | rotary apparatus |
| 12 | transport starwheel |
| 14 | support frame |
| 16 | cut-out |
| 18 | rotor plate |
| 20 | container holder |
| 22 | processing device |
| 24 | sealing system |
| 26 | lubricant channel |
| 28 | further lubricant channel |
| 30 | wall |
| 32 | lubricant drain |
| 34 | collar |
| 36 | collar |
| 38 | recess |
| 40 | inner circumferential surface |
| 42 | bottom surface |
| 44 | outer circumferential surface |
| 46 | breakwater contour |
| 48 | depression |
| 50 | drip edge contour |
| 52 | underside surface |
| 54 | drip edge contour |
| 56 | sealing ring |
| 58 | sealing lip |
| 60 | ventilation element |
| 62 | through-hole |
| 64 | ventilation duct |
| 66 | sealing assembly |
| 68 | sleeve part |
| 70 | passage |
| 72 | sealing ring |
| 74 | sealing screw |
| 76 | sealing ring |
| A | main axis |
| B | container processing space |
| S | lubricant space |

1. A rotary apparatus, for a container processing plant, wherein the rotary apparatus comprises:
a support frame having a cut-out and an annular lubricant channel surrounding the cut-out; and
a rotor plate which is arranged in the cut-out such as to be rotatable relative to the support frame and has an annular collar which extends into the lubricant channel from above.

2. The rotary apparatus according to claim 1, wherein at least one of the following conditions is met:
the collar of the rotor plate is arranged on an outer circumference of the rotor plate; and
the collar (36) of the rotor plate (18) is arranged on an underside of the rotor plate (18).

3. The rotary apparatus according to claim 1, wherein at least one of the following conditions is met:
the support frame and the rotor plate are arranged above or below a container processing space of the rotary apparatus; and
the support frame and the rotor plate are components of a upper or lower part of the rotary apparatus.

4. The rotary apparatus according to claim 1, wherein:
the support frame encloses a lubricant space for receiving lubricant spray mist; and
the lubricant space is arranged above the lubricant channel and extends all the way to the lubricant channel for supplying the lubricant channel with the lubricant from the lubricant space.

5. The rotary apparatus according to claim 1, wherein:
the support frame has an annular further lubricant channel which surrounds the lubricant channel; and
the further lubricant channel and the lubricant channel are separated from each other by an annular wall.

6. The rotary apparatus according to claim 1, wherein:
the rotor plate is rotatable about a main axis of rotation of the rotary apparatus; and
wherein:
the rotor plate is connected to processing devices for processing at least one of the containers and to container holders for rotating at least one of the processing devices and the container holders about the main axis of rotation of the rotary apparatus; or
the rotor plate is connected to closing tools or crimping tools for processing the containers for rotating the closing tools or crimping tools about the main axis of rotation of the rotary apparatus.

7. The rotary apparatus according to claim 1, further comprising:
a sealing ring which is arranged radially inwardly of the collar of at least one of the rotor plate and the lubricant channel of the support frame and seals between the rotor plate.

8. The rotary apparatus according to claim 1, wherein:
the rotor plate has an annular recess on its underside; and
the support frame has an annular collar which projects into the recess.

9. The rotary apparatus according to claim 7, wherein:
the sealing ring is arranged in the recess and seals between the rotor plate and the collar of the support frame.

10. The rotary apparatus according to claim 8, wherein at least one of the following conditions is met:
a bottom surface of the recess has a drip edge contour for interrupting a centrifugally induced droplet movement radially outwards;
an inner circumferential surface of the recess has a breakwater contour for throwing back liquid penetrating the recess from below;
a transition between an inner circumferential surface of the recess and a bottom surface of the recess has a depression for reducing a capillary effect between an inner circumferential surface of the recess and the collar of the support frame; and
an underside surface of the rotor plate radially inwardly adjacent to the recess has a drip edge contour for interrupting a centrifugally induced droplet movement radially outwards towards the recess.

11. The rotary apparatus according to claim 8, further comprising:
a venting element wherein the venting element is releasably arranged in a through-hole of the rotor plate connected to the recess for reducing pressure in the recess.

12. The rotary apparatus according to claim 8, further comprising:
a sealing assembly having a sleeve part and a sealing screw,
wherein:
the sleeve part is arranged on an upper side of the rotor plate, and extends into a passage of the rotor plate;
the passage extends from the upper side of the rotor plate to the recess; and
the sealing screw is sealed and releasably screwed into the sleeve part.

13. A method for sealing a rotary apparatus, or a rotary closing apparatus or a rotary can closing apparatus, wherein the method comprises:
blocking a fluid path through a gap between a rotor plate of the rotary apparatus and a support frame of the rotary apparatus by an annular collar of the rotor plate which extends into an annular lubricant channel of the support frame filled with lubricant.

14. The method according to claim 13, further comprising at least one of the following:
cleaning an underside of the rotor plate with a cleaning medium, wherein penetration of the cleaning medium into a lubricant space enclosed by the support frame is prevented by the blocked fluid path;
replenishing or continuously replenishing the lubricant in the lubricant channel from a lubricant spray mist from a lubricant space enclosed by the support frame, which is arranged above the lubricant channel and extends all the way to the lubricant channel; and
sealing the gap with a sealing ring.

15. The method according to claim 13, wherein the rotor plate has an annular recess on its underside, and the support frame has an annular collar which projects into the recess, wherein the method further comprises at least one of:
reducing pressure in the recess by a venting element;
reducing a fluid flow through the recess by at least one of:
a drip edge contour on a bottom surface of the recess which interrupts a centrifugally induced droplet movement radially outwards;
a breakwater contour on an inner circumferential surface of the recess which throws back liquid penetrating the recess from below;
a depression at a transition between an inner circumferential surface of the recess and a bottom surface of the recess, which reduces a capillary effect between the inner circumferential surface of the recess and the collar of the support frame; and
a drip edge contour on an underside surface of the rotor plate radially inwardly adjacent to the recess, which interrupts a centrifugally induced droplet movement radially outwards towards the recess.

16. The rotary apparatus according to claim 1, wherein at least one of:
the rotary apparatus is a rotary closing apparatus or a rotary can-seaming apparatus;
the annular collar extends into the lubricant channel from above for sealing a gap between the rotor plate and the support frame by lubricant received in the lubricant channel;
the support frame and the rotor plate are arranged directly above or below a container processing space of the rotary apparatus; and
the support frame and the rotor plate are components of a height-adjustable upper or lower part of the rotary apparatus.

17. The rotary apparatus according to claim 5, wherein at least one of:
the annular further lubricant channel surrounds the lubricant channel coaxially;
the annular further lubricant channel has an inlet of a lubricant drain for discharging lubricant from the further lubricant channel;
the annular wall having a wall height>5 mm;
the annular wall having a wall height<20 mm; and
the annular wall having a wall height approximately 10 mm.

18. The rotary apparatus according to claim 7, wherein at least one of:
the sealing ring seals between an underside of the rotor plate and the support frame;
the sealing ring has a sealing lip which contacts the rotor plate;
the sealing ring has a sealing lip which contacts the rotor plate which contacts the rotor plate from below; and
the sealing ring is accommodated in the rotor plate.

19. The rotary apparatus according to claim 8, wherein at least one of:
the recess is delimited on an outer circumference by the collar of the rotor plate;
the annular collar delimits the lubricant channel on an inner circumference;
the sealing ring is arranged at an upper end of the collar of the support frame; and
the sealing ring is arranged and supported at an upper end of the collar of the support frame.

20. The rotary apparatus according to claim 11, wherein at least one of:
the venting element is a venting screw;
the venting element is releasably screwed into the through-hole;
the through-hole opens in a region of the recess between the collar of the support frame and the collar of the rotor plate;
the through-hole opens in an upper side or outer circumferential side of the rotor plate;
the sleeve part is sealed to the upper side of the rotor plate;
the sleeve part is screwed into the passage; and
